(19) United States
(12) Patent Application Publication
(10) Pub. No.: US 2018/0283423 A1
(43) Pub. Date: Oct. 4, 2018

(54) SELF-PIERCING RIVET WITH A CONCAVE LOWER SURFACE

(71) Applicant: FORD GLOBAL TECHNOLOGIES, LLC, Dearborn, MI (US)

(72) Inventors: Garret Sankey HUFF, Ann Arbor, MI (US); Katherine Avery VOZAR, Saline, MI (US); Amanda Kay FREIS, Ann Arbor, MI (US)

(21) Appl. No.: 15/474,292

(22) Filed: Mar. 30, 2017

(51) Int. Cl. F16B 5/04; F16B 19/08

(52) U.S. Cl. CPC F16B 5/04; F16B 19/086

(57) ABSTRACT

A self-piercing rivet includes a barrel having a cutting edge formed on an insertion tip and a head is formed on an opposite end of the barrel from the insertion tip. The head includes a concave inner surface, or a recess, that includes a peripheral edge radially aligned outboard of a cylindrical outer surface of the barrel adjacent the head. An assembly is disclosed that includes at least two panels that are joined by one or more self-piercing rivets that include a head provided having a concave inner surface. A peripheral edge is configured to form a contact ring that has continuous contact with the outer surface of the first panel to form a closed arcuate recess between the barrel and the periphery of the head.

### TECHNICAL FIELD

The disclosure relates to self-piercing rivets that are used to join parts and form a peripheral overhanging seal around the perimeter of the head of the rivet when installed on a panel.

### BACKGROUND

Self-piercing rivets are used to join two or more parts that are generally provided in sheet form. Self-piercing rivets are well-suited for joining dissimilar materials that may include fiber-reinforced composite materials, advanced high strength materials and other lightweight materials.

Some assemblies may include diverse stack-ups of different high strength or brittle materials. Available self-piercing rivet designs include countersunk closed head rivets (FIG. 1), tubular rivets (FIG. 2) and pan-head closed head rivets (FIG. 3).

Rivets inserted into brittle materials may create small cracks in the material that reduce the strength and durability of the riveted assembly in the normal or shear loading directions. The small cracks in the sheets of brittle materials can extend outboard of countersunk closed head rivets, tubular rivets and pan-head closed head rivets (FIG. 4). The cracks may allow water to penetrate the top sheet or leak through to subsurface sheets around the barrel of the rivet. The presence of water at the interior of the joint can cause corrosion, which can degrade the joint performance.

This disclosure is directed to solving the above problems and other problems as summarized below.

### SUMMARY

The proposed rivet geometry can prevent water seepage into a riveted joint inserted into brittle materials that may create small cracks in the material that reduce the strength and durability of the riveted assembly in the normal or shear loading directions. In addition, the proposed geometry can also provide significant resistance to an applied load normal to the surface of the brittle sheet due to the larger footprint of the rivet head on the sheet material.

According to one aspect of this disclosure, a self-piercing rivet is disclosed that includes a tubular barrel portion and a head. The tubular barrel has a cutting edge formed on an insertion tip. The head is formed on an opposite end of the barrel from the insertion tip and defines an opening extending at least partially through the tubular barrel from the insertion tip. The head includes a concave semi-toroidal surface including a peripheral edge radially aligned outboard of the tubular barrel where the barrel joins the head.

According to another aspect of this disclosure, a self-piercing rivet is disclosed that includes a rivet barrel having a cylindrical outer surface and an insertion tip including a circular cutting edge provided on a first end of the rivet barrel. A head is provided on a second end of the rivet barrel that has a recessed semi-toroidal surface defined in the cross-section between an outer peripheral edge of the head and the cylindrical outer surface of the rivet barrel. The term semi-toroidal surface as used herein means a lower surface concave to a plane extending from the peripheral edge of the head to the location where the head is joined to the barrel. The concave surface may extend about a radial arc of between 100 and 190 degrees. More specifically, the surface may extend about a radial arc of between 150 and 180 degrees.

According to other aspects of the self-piercing rivets described above, the head may have a flat top portion and may include an outer surface that extends radially outward from the flat top portion and is convex from a plane intersecting a the flat portion.

A plane may extend through the peripheral edge of the concave semi-toroidal surface and through the cylindrical outer surface of the tubular barrel adjacent the head. The concave surface may define a recessed area below the head in which material displaced form a top sheet as the rivet is inserted into an assembly may accumulate. The peripheral edge of the head is compressed against the top sheet.

According to another aspect of this disclosure, an assembly is disclosed that includes at least two panels that are joined by one or more self-piercing rivets. The self-piercing rivet includes a head provided on a barrel that includes a concave semi-toroidal surface including a peripheral edge that engages the outer surface of the first panel when the rivet is in a design inserted condition with the barrel being fully driven through the first sheet.

According to other aspects of this disclosure as it relates to the panel assembly, the concave surface may include an inner radial edge where the head is joined to a cylindrical outer surface of the barrel. The peripheral edge is configured to form a contact ring, or seal, that has continuous contact with the outer surface of the first panel to form a closed arcuate recess between the barrel and the periphery of the head.

The barrel and the head may define a central opening that extends completely through the self-piercing rivet.

The first panel may be a fiber-reinforced polymer matrix composite sheet, a high strength steel sheet, an aluminum sheet, or a magnesium sheet.

The above aspects of this disclosure and other aspects will be described below with reference to the attached drawings.

### BRIEF DESCRIPTION OF THE DRAWINGS

FIG. 1 is a side elevation view of a prior art A-head rivet.

FIG. 2 is a side elevation view of a prior art C-head rivet.

FIG. 3 is a side elevation view of a prior art pan head rivet.

FIG. 4 is a cross-section of a prior art pan head rivet inserted into a stack of two lightweight metal or polymer matrix composite sheets.

FIG. 5 is a cross-sectional view of a fully tubular self-piercing rivet made according to one embodiment of this disclosure.

FIG. 6 is a cross-sectional view of a partially tubular self-piercing rivet made according to one embodiment of this disclosure.

FIG. 7 is a cross-sectional view of the self-piercing rivet shown in FIG. 1 partially installed into two panels.

FIG. 8 is a cross-sectional view of the self-piercing rivet shown in FIG. 1 fully installed in two panels.

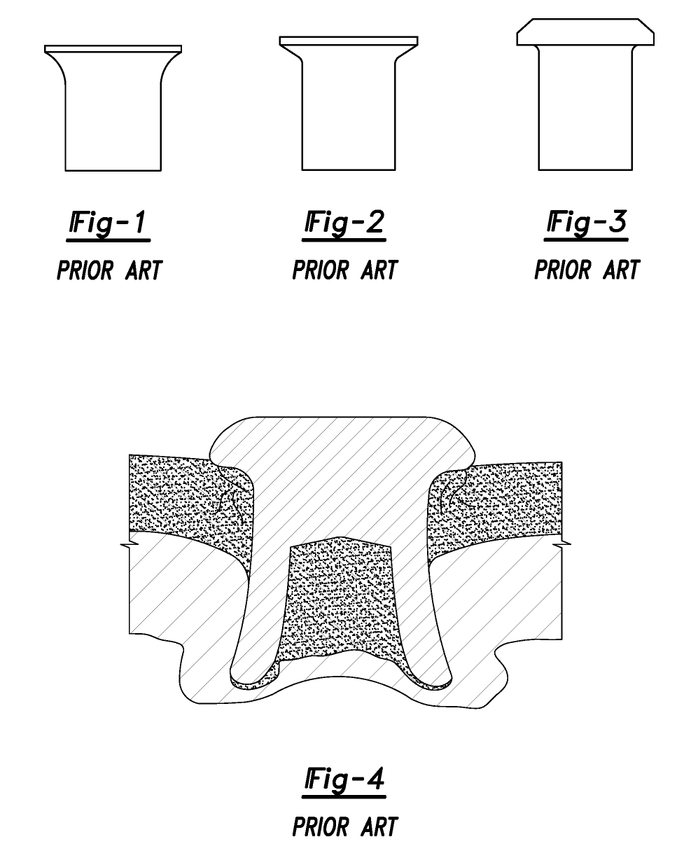

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show particular details of components. The specific structural and functional details disclosed are not to be interpreted as limiting, but as a representative basis for teaching one skilled in the art how to practice the disclosed concepts.

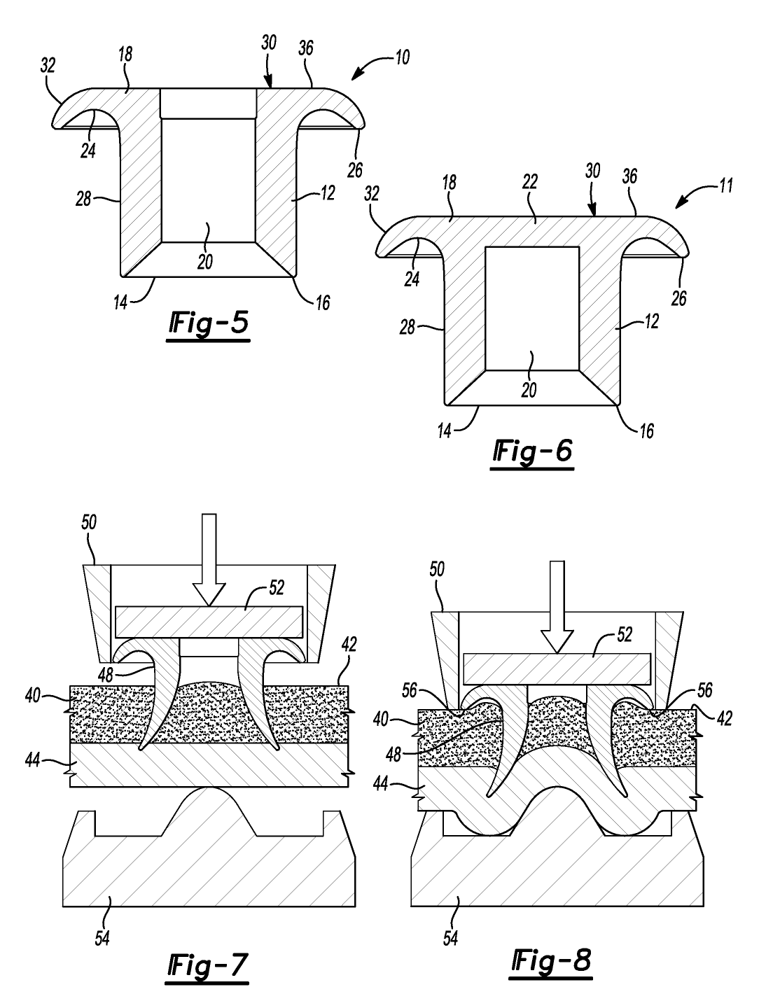

Referring to FIG. 5, a self-piercing rivet 10 is shown to include a tubular barrel 12. A cutting edge 14 is formed on the tubular barrel 12 on an insertion tip 16. The insertion tip 16 is formed on a first end of the tubular barrel 12. The tubular barrel 12 is tubular throughout its length. A head 18 is formed on a second end of the tubular barrel 12 that is opposite the first end, or insertion tip 16, of the tubular barrel 12. An opening 20 is provided through the self-piercing rivet 10 that the extends through the head 18 and the tubular barrel 12 to the insertion tip 16.

Referring to FIG. 6, a closed head self-piercing rivet 11 is illustrated that includes a closed head 22. The other parts of the rivet 11 are the same as the parts of FIG. 5 and the same reference numerals are used to refer to the equivalent parts as are used in FIG. 5.

Referring to FIGS. 5 and 6, the head 18 of the tubular self-piercing rivet 10 includes a concave surface 24, or concave lower surface, that may also be referred to as a recessed surface. An outer peripheral edge 26 is provided on the head 18. The outer peripheral edge 26 engages the outer surface of the panel when the rivet 10 is in a design inserted condition with the barrel 12 being fully driven through the first sheet.

The concave surface 24 defines a recess in which material displaced by the riveting process may accumulate when the rivet 10 is installed. The outer peripheral edge 26 engages the outer surface of the panel when the rivet 10 is in a design inserted condition with the barrel 12 being fully driven through the top panel and into one or more panels below the top panel.

The tubular barrel 12 includes a cylindrical outer surface 28. The cylindrical outer surface 28 extends to a point where the surface is adjacent to the head 18. The head 18 also has an outer surface 30 that includes a convex portion 32 extending outwardly from a flat top portion 36. The panels that the rivet is inserted through are described more particularly below with reference to FIGS. 3 and 4.

Referring to FIG. 7, a first panel 40 has an outer surface 42 through which one or more of the self-piercing rivets 10 may be inserted. The first panel 40 is placed in contact with a second panel 44 prior to insertion of the self-piercing rivet 10. The self-piercing rivet 10 is shown as the rivet is being inserted through the first and second panels 40 and 44. It should be understood, that three or more panels may be joined to form an assembly of panels. A riveting tool 50 is partially illustrated that includes a punch 52 used to drive the self-piercing rivet 10 through the first and second panels 40 and 44. A die 54 engages the second panel 44 while the rivet 10 is inserted into the panels.

Referring to FIG. 8, the self-piercing rivet 10 is shown after being deformed as a result of being driven into the first and second panels 40 and 44. The riveting tool 50 is shown with the punch 52 driving the self-piercing rivet 10 until the rivet is in the fully-inserted condition. The rivet head 18 and the punch 52 may be spaced from the top surface 42 when the rivet 10 is properly installed. The insertion tip 16 on the tubular barrel 12 is deformed radially outwardly to hold the first and second panels 40 and 44 together. The panels 40 and 44 are held together and compressed between the insertion tip and the peripheral edge 26.

The outer peripheral edge 26 is deformed outwardly and is shown to form a contact ring 56 on the top surface 42 of the first panel 40. The outer peripheral edge 26 of the head 18 is spaced radially outwardly from the inner radially edge 48 of the tubular barrel 12. The outer peripheral edge 26 of the head 18 does not penetrate into the outer surface 42 of the first panel 40 and reduces the possibility that cracks will form in the first panel 40 adjacent and outboard of the rivet location. This substantially reduces the possibility of water leaking through cracks around the tubular barrel 12 after it is inserted into the first and second panels 40 and 44, and improves the strength of the joint in the direction perpendicular to the rivet head 18.

The peripheral edge 26 makes continuous contact in a ring where the edge 26 touches the outer surface of the first panel 40 to form a closed arcuate recess between the barrel and the periphery of the head. The recess provides an area for material displaced by the rivet 10 during insertion to accumulate and facilitates full insertion of the rivet 10.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A self-piercing rivet comprising:
a barrel having a cutting edge formed on an insertion tip; and
a head formed on an opposite end of the barrel from the insertion tip, the head defines an opening extending at least partially through the barrel from the insertion tip, and wherein the head includes a concave inner surface including a peripheral edge radially aligned outboard of the barrel where the barrel joins the head.

2. The self-piercing rivet of claim 1 wherein the head includes an outer surface on an opposite side of the concave inner surface.

3. The self-piercing rivet of claim 1 wherein the concave inner surface extends outwardly from the barrel about an arc of between 100 and 190 degrees.

4. The self-piercing rivet of claim 1 wherein a plane extending through the peripheral edge of the concave inner surface extends through the barrel where the barrel joins the head.

5. The self-piercing rivet of claim 1 wherein the concave inner surface defines an undercut area below the head in which material displaced from a top sheet as the self-piercing rivet is inserted into an assembly may accumulate, wherein the peripheral edge of the head is compressed against the top sheet.

6. A self-piercing rivet comprising:
a rivet barrel having a cylindrical outer surface;
an insertion tip including a circular cutting edge provided on a first end of the rivet barrel; and
a head provided on a second end of the rivet barrel, the head having a concave inner surface that defines an undercut recess between an outer peripheral edge of the head and the cylindrical outer surface of the rivet barrel.

7. The self-piercing rivet of claim 6 wherein the head includes an outer surface on an opposite side of the concave inner surface that is a convex portion that extends radially outwardly from a flat top portion.

8. The self-piercing rivet of claim 6 wherein the concave inner surface extends about an arc of between 150 and 180 degrees.

9. The self-piercing rivet of claim 6 wherein a plane extending through the outer peripheral edge of the concave inner surface extends through the cylindrical outer surface of the rivet barrel where the rivet barrel is connected to the head.

10. An assembly comprising:
a first panel having an outer surface;
a second panel contacting the first panel; and
a self-piercing rivet joining the first and second panels that includes a head provided on a barrel that includes a concave semi-toroidal surface including a peripheral edge that engages the outer surface of the first panel when the self-piercing rivet is in a design fully inserted condition with the barrel being fully driven through the first panel.

11. The assembly of claim 10 wherein the concave semi-toroidal surface includes an inner radial edge where the head is joined to a cylindrical outer surface of the barrel.

12. The assembly of claim 10 wherein the barrel and the head define a central opening that extends at least partially through the self-piercing rivet.

13. The assembly of claim 10 wherein the peripheral edge forms a continuous contact ring touching the outer surface of the first panel to form a closed arcuate recess between the barrel and the peripheral edge.

14. The assembly of claim 10 wherein the first panel is a polymer matrix composite sheet reinforced with carbon, glass or organic fibers. .

15. The assembly of claim 10 wherein the first panel is a lightweight metal sheet such as aluminum, magnesium, high strength steel, or similar metal.
